(19) United States
(12) Patent Application Publication
(10) Pub. No.: US 2011/0252922 A1
(43) Pub. Date: Oct. 20, 2011

(54) METHOD OF PRODUCING A DIFFUSION ALLOYED IRON OR IRON-BASED POWDER, A DIFFUSION ALLOYED POWDER, A COMPOSITION INCLUDING THE DIFFUSION ALLOYED POWDER, AND A COMPACTED AND SINTERED PART PRODUCED FROM THE COMPOSITION

(75) Inventor: Mats Larsson, Helsingborg (SE)

(73) Assignee: HOGANAS AB (PUBL)

(21) Appl. No.: 13/132,974

(22) PCT Filed: Dec. 16, 2009
(86) PCT No.: PCT/SE2009/051434

§ 371 Date: Jun. 27, 2011

Related U.S. Application Data
(60) Provisional application No. 61/140,093, filed on Dec. 23, 2008.

(30) Foreign Application Priority Data
Dec. 23, 2008 (SE) 0802666-8

(51) Int. Cl. B22F 1/00; B32B 15/02; B22F 9/04

(52) U.S. Cl. 75/243; 75/351; 75/352; 75/252; 428/570

(57) ABSTRACT

A method is provided for producing a diffusion alloyed powder consisting of an iron or iron-based core powder having particles of an alloying powder containing Cu and Ni bonded to the surface of the core particles, comprising providing a unitary alloying powder capable of forming particles of a Cu and Ni containing alloy, mixing the unitary alloying powder with the core powder, and heating the mixed powders in a non-oxidizing or reducing atmosphere to a temperature of 500-1000° C. during a period of 10-120 minutes to convert the alloying powder into a Cu and Ni containing alloy, so as to diffusion bond particles of the Cu and Ni alloy to the surface of the iron or iron-based core powder. The alloying powder may be a Cu and Ni alloy, oxide, carbonate or other suitable compound that on heating will form a Cu and Ni alloy. Preferably, the total content of Cu and Ni is at most 20 wt %, the particle size distribution of the Cu and Ni alloying powder is such that D₅₀ is less than 15 μm, and the ratio Cu/Ni in wt % is between 9/1 and 3/1. The compacted and sintered parts produced from the diffusion alloyed iron-based powder present a minimum of variation of dimensional change from component to component.

### TECHNICAL FIELD

Generally, the present invention relates to a new diffusion alloyed iron or iron-based powder suitable for preparing sintered powder metallurgical components there from, as well as a method for producing the new powder.

More specifically, the invention refers to a new method of producing a diffusion alloyed powder consisting of an iron or iron-based core powder having particles of an alloying powder containing copper and nickel bonded to the surface of the core particles.

The invention also relates to a diffusion alloyed iron or iron-based core powder having particles of an alloying powder bonded to the surface of the core particles.

Further, the invention relates to a diffusion alloyed iron or iron-based powder composition.

Still further, the invention relates to a compacted and sintered part produced from the diffusion alloyed iron-based powder composition.

### BACKGROUND ART

A major advantage of powder metallurgical processes over conventional technique, such as forging or casting, is that components of varying complexity can be produced by pressing and sintering into final shape, requiring a relatively limited machining. Therefore, it is of outmost importance that the dimensional change during sintering is predictable and that the variation in dimensional change from part to part is as small as possible. This is especially important in the case of high strength steel, which is difficult to machine after sintering.

Consequently, materials and processes giving little dimensional change during sintering are preferred, since a dimensional change between the compacted and the sintered part of close to zero inherently leads to reduced variation in the dimensional change from part to part.

In order to achieve sufficiently high values of mechanical properties, such as tensile strength, toughness, hardness and fatigue strength, various alloying elements and alloying systems are used.

A commonly used alloying element is carbon, which effectively increases the strength and hardness of the sintered component. Carbon is almost always added as graphite powder and mixed with the iron-based powder before compaction, as the compressibility of the iron-based powder would be ruined due to the hardening effect of carbon if the element would be prealloyed to the iron-based powder.

Another commonly used element is copper, which also improves the hardenability of the sintered component and in addition promotes sintering, since a liquid phase that enhances diffusion is formed at the sintering temperatures. A problem when using particulate copper is that it causes swelling during sintering.

Nickel is another element commonly used for its hardenablity increasing effect and also for its positive effect on toughness and elongation. Nickel causes shrinkage during sintering, added as particulate material as well as added in pre-alloyed condition to the iron-based powder.

Copper and nickel may be added as prealloyed elements and as particulate materials. The advantage by adding copper and nickel as particulate materials is that the compressibility of the softer iron-based powder will be unaffected compared to when the alloying elements are prealloyed. However, a drawback is that the alloying elements, which in most cases are considerably finer than the iron-based powder, tend to segregate in the mixture causing variations in chemical composition and mechanical properties of the sintered components. Therefore, various methods have been invented in order to prevent segregation but maintain the compressibility of the base powder.

Diffusion alloying is one such method, which comprises blending fine particulate alloying elements, in metal or oxide state, with the iron-based powder followed by an annealing step at such conditions that the alloying metals are diffused into the surface of the iron-based powder. The result is a partially alloyed powder having good compressibility and the alloying elements are prevented to segregate. Carbon however is an element which is not possible to diffusion alloy due to its high diffusion rate.

Another developed method, for example described in U.S. Pat. No. 5,926,686 (Engström et al.), utilize organic binders which creates a “mechanical” bond between the base powder and the alloying elements. This method is suitable also to bind graphite hence preventing carbon segregation.

A plurality of diffusion alloyed iron-based powders, utilizing the alloying effect of copper and/or nickel, has been suggested in the patent literature. Examples thereof are found in the following documents.

U.S. Pat. No. 5,567,890 (Lindberg et al.) discloses an iron-based powder for producing highly resistant components with a small local variation in dimensional change. The powder contains 0.5-4.5% by weight of Ni, 0.65-2.25% by weight of Mo, and 0.35-0.65% by weight of C. In a preferred embodiment, Ni is diffusion alloyed to an iron-based powder prealloyed with Mo, the powder being mixed with graphite.

US 2008/0089801 (Larsson) describes a metal powder combination comprising an iron-based powder A, consisting essentially of core particles prealloyed with Mo and having 6-15% of Cu diffusion bonded to the surface, a powder B consisting essentially of core particles prealloyed with Mo and having 4.5-8% of Ni bonded to the surface thereof, and an iron-based powder C consisting essentially of iron powder prealloyed with Mo. The powder combination enables production of sintered parts, in which a dimensional change during sintering is independent of the amount of added graphite.

JP 6116601 discloses a powder that is suitable for production of sintered parts having high static and dynamic mechanical strength and low variation of the dimensional change during sintering. The powder consists of an iron-base powder, having at least one of the components 0.1-2.5% Mo, 0.5-5.0% Ni, and 0.5-3.0% Cu, diffusion bonded to the surface of the iron particles.

JP 2145702 discloses a high purity iron powder having at least two of the components 0.5-1.0 of Mo powder, 6-8% of Ni powder and up to 2% of Cu powder, diffusion bonded to the surface of the iron powder. The powder is suitable for production of sintered bodies having high mechanical strength.

JP 2217401 discloses an iron-based powder composition obtained by mixing two powders: [1] an alloy produced by adding metal powders to obtain a mixing rate of 0.1-5% Ni and 0.1-2% Cu and annealing and [2] an alloy produced by adding a Ni-Cu alloy to a reduced iron powder to obtain a mixing rate of 0.1-5% Ni and 0.1-2% Cu and annealing. Dimensional change of sintered parts made from the powder varies with mixing rates.

### SUMMARY OF THE INVENTION

An object of the invention is to provide a new method of producing an iron or iron-based core powder containing diffusion bonded copper and nickel, which when compacted and sintered shows reduced swelling and a minimum of scatter of the dimensional change during sintering, related to variations in the carbon content and sintering temperature.

Variations in carbon content and sintering temperature are normally occurring in industrial production. Thus, the present invention provides a method to substantially reduce the impact of such variations.

Further, an object of the invention is to provide a new diffusion bonded iron or iron-based core powder having particles of an alloying powder bonded to the surface of the core particles, which when compacted and sintered shows reduced swelling and a minimum of scatter of the dimensional change during sintering, related to variations in the carbon content and sintering temperature.

Still further, it is an object of the invention to provide a new diffusion alloyed iron or iron-based powder composition for powder metallurgical manufacturing of compacted and sintered parts and having a minimum of dimensional change during the sintering process.

Finally, it is an object of the invention to provide a compacted and sintered part produced from the diffusion alloyed iron-based powder composition and presenting a minimum of variation of the dimensional change from component to component.

In accordance with the present invention these objects are achieved by providing a unitary alloying powder capable of forming particles of a Cu and Ni containing alloy, mixing the unitary alloying powder with the core powder, and heating the mixed powders in a non-oxidizing or reducing atmosphere to a temperature of 500-1000° C. during a period of 10-120 minutes to convert the alloying powder into a Cu and Ni containing alloy, so as to diffusion bond particles of the Cu and Ni alloy to the surface of the iron or iron-based core powder. Preferably, the total content of Cu and Ni is below 20 wt %, such as between 1-20 wt %, preferably 4-16 wt %. Preferably the content of Cu is above 4.0 wt %. In a preferred embodiment the content of Cu is between 5-15 wt % and the content of Ni is between 0.5 -5%, such as Cu 8-12 wt % and Ni 1-4.5 wt %.

According to one aspect of the present invention, there is provided a method of producing a diffusion alloyed powder, comprising a total content of copper and nickel of at most 20% by weight, wherein the copper content is above 4.0 wt % and the ratio between copper and nickel is between 9/1 and 3/1, said powder consisting of an iron or iron-based core powder having particles of an alloying powder containing copper and nickel bonded to the surface of the core powder particles, comprising: providing a unitary alloying powder comprising copper and nickel, said unitary alloying powder having a particle size distribution such that D50 is less than 15 μm; mixing the unitary alloying powder with the core powder; and heating the mixed powders in a non-oxidizing or reducing atmosphere to a temperature of 500-1000° C. during a period of 10-120 minutes to convert the alloying powder into a copper and nickel containing alloy by diffusion bonding particles of the copper and nickel alloying powder to the surface of the iron or iron-based core powder.

According to another aspect of the present invention, there is provided a diffusion alloyed powder comprising a total content of copper and nickel of at most 20% by weight, wherein the copper content is above 4.0 wt % and the ratio between copper and nickel is between 9/1 and 3/1, said powder consisting of an iron or iron-based core powder having particles of an average size less than 15 μm of a unitary alloying powder containing copper and nickel bonded to the surface of the core particles.

According to another aspect of the present invention, there is provided a diffusion alloyed iron or iron-based powder composition comprising the diffusion alloyed powder of the above aspect of the present invention, and in addition comprising graphite and optionally at least one additive selected from the group consisting of organic lubricants, hard phase materials, solid lubricants and other alloying substances.

According to another aspect of the present invention, there is provided an iron based powder composition consisting of: an iron or iron-based powder; a diffusion alloyed powder of the above aspect of the present invention; up to 1% by weight of graphite; and optionally at least one additive selected from the group consisting of organic lubricants, hard phase materials, solid lubricants and other alloying substances.

The term “unitary powder” in this context designates a powder, the separate particles of which contain both Cu and Ni. Thus, it is not a mixture of powder particles containing Cu and other powder particles containing Ni, but e.g. alloy powder particles comprising both Cu and Ni or complex powder particles where different types of particles are bonded to each other to form complex particles each of which comprises both Cu and Ni.

The alloying powder may be a Cu and Ni alloy, oxide, carbonate or other suitable compound that on heating will form a Cu and Ni alloy. The particle size distribution of the Cu and Ni alloying powder is such that D₅₀ is less than 15 μm, and the ratio Cu/Ni in wt % is between 9/1 and 3/1.

It has now surprisingly been found, that a minimum of dimensional change during sintering of a compacted iron-based powder containing the alloying elements copper and nickel can be obtained provided that copper and nickel are present in a unitary alloying powder comprising both the copper and the nickel, which is diffusion alloyed to the iron-based powder particles.

### BRIEF DESCRIPTION OF THE DRAWINGS

In the following, the invention will be described in more detail with reference to preferred embodiments and the appended drawings.

FIG. 1 is a diagram showing the hardness HV10 of pressed and sintered samples as a function of the Cu to Ni ratio at various mean particle sizes D₅₀ of the alloying powders.

FIG. 2 is a diagram showing the tensile strength (MPa) of pressed and sintered samples as a function of the Cu to Ni ratio at various mean particle sizes D₅₀ of the alloying powders.

FIG. 3 is a diagram showing the scatter of dimensional change of the samples during sintering as a function of the Cu to Ni ratio at various mean particle sizes D₅₀ of the alloying powders.

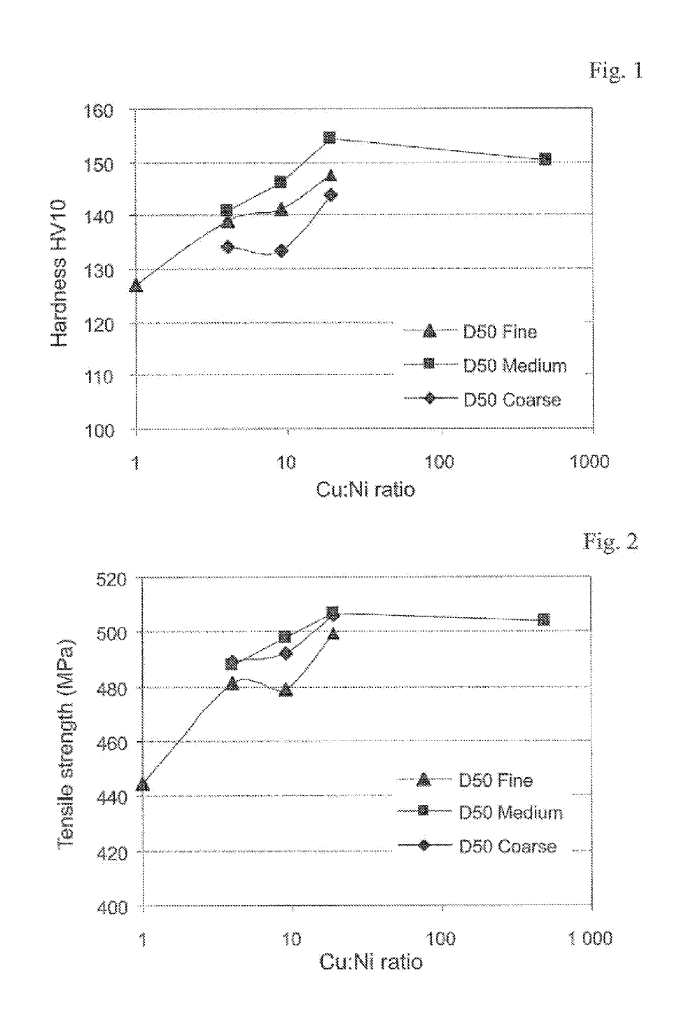

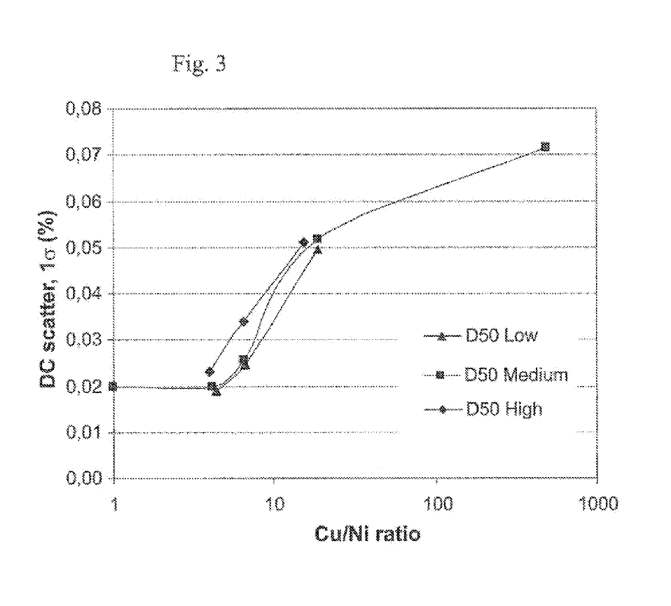

### MODES FOR CARRYING OUT THE INVENTION

Base Powder for Producing the Diffusion Alloyed Powder

The base powder is preferably a pure iron-based powder such as AHC100.29, ASC100.29 and ABC100.30 all available from Höganäs AB, Sweden. However, other pre-alloyed iron-based powders may also be used.

Particle Size of the Base Powder

There are no restrictions as to the particle size of the base powder and, consequently, nor to the diffusion alloyed iron-based powder. However, it is preferred to use powder a particle size normally used within the PM industry.

Copper and Nickel Containing Unitary Alloying Powder

The copper and nickel containing alloying substance to be adhered to the surface of the iron-based powder can be in the form of a metal alloy, an oxide or a carbonate or in any other form resulting in an iron-based powder according to the present invention. The relation between copper and nickel, Ni (% by weight)/Cu (% by weight) is preferably between 1/3 and 1/9 in the copper and nickel containing alloying substance. If the weight ratio between Ni and Cu is above 1/3, the effect on hardness and yield strength will be unacceptable and if the ratio is below 1/9 the scatter of the dimensional change due to varying carbon content and sintering temperature will be too high, above about 0.035 wt % according to the methodology described herein.

The particle size of the copper and nickel containing alloying powder preferably is such that D₅₀, meaning that 50% by weight of the powder has particle size less than the D₅₀ value, preferably is below 15 μm, more preferably below 13 μm, most preferably below 10 μm.

Production of the New Powder

The base powder and the copper and nickel containing alloying powder are mixed in such proportions that the total content of copper and nickel in the new powder will be at most 20% by weight, preferably between 1% and 20% by weight, and more preferably between 4% and 16% by weight. Preferably the content of Cu is above 4.0 wt %. In a preferred embodiment the content of Cu is between 5-15 wt % and the content of Ni is between 0.5-5%, such as Cu 8-12 wt % and Ni 1-4.5 wt %.

A low content, such as a content below 1% by weight is believed to be too low in order to obtain desired mechanical properties of the sintered component. If the content of the copper and nickel containing alloying powder exceeds 20%, bonding of the alloying powder to the base powder will be insufficient and increase the risk for segregation.

The homogeneous mix is then subjected to a diffusion annealing process, wherein the powder is heated in a reducing atmosphere up to a temperature of 500-1000° C. during period of 10-120 minutes. The obtained diffusion bonded powder, in the form of a weakly sintered cake, is then crushed gently.

Production of Sintered Components

Before compaction, the new powder is mixed with graphite, up to 1% by weight depending on the intended use of the finished component, organic lubricants up to 2% by weight, preferably between 0.05 to 1% by weight, optionally other alloying substances, hard phase materials and inorganic solid lubricants rendering lubricating properties of the finished component.

The organic lubricant reduces interparticular friction between the individual particles and also the friction between the wall of the mould and the compressed powder or ejected compressed body during compaction and ejection.

The solid lubricants may be chosen from the group of stearates, such as zinc sterate, amides or bis-amides such as ethylene-bis-stearamide, fatty acids such as stearic acid, Kenolube®, other organic substances or combinations thereof, having suitable lubricating properties.

The new powder may be diluted with a pure iron powder or an iron-based powder in order to obtain a iron-based powder composition wherein the total copper and nickel content does not exceed 5% by weight of the composition, such as between 0.5% and 4.5% by weight or between 1.0% and 4.0% by weight, since a content above 5% by weight may not cost-effectively contribute to improved desired properties. The relation between copper and nickel in the diluted alloy, Ni (% by weight)/Cu (% by weight) is preferably between 1/3 and 1/9.

The obtained iron powder composition is transferred to a compaction mould and compacted at ambient or elevated temperature to a compacted “green” body at a compaction pressure up to 2000 MPa, preferably between 400-1000 MPa.

Sintering of the green body is performed in a non-oxidizing atmosphere, at a temperature of between 1000 to 1300° C., preferably between 1050-1250° C.

### EXAMPLES

The following examples illustrate the invention.

### Example 1

Three samples of diffusion bonded iron-based powders were produced by first blending different alloying powders, cuprous oxide Cu₂O, Cu₂O+Ni powder and a Cu and Ni containing powder with a iron powder, ASC100.29.

The homogenous blended powder mixes were diffusion annealed at 800° C. for 60 minutes in an atmosphere of 75% hydrogen/25% nitrogen. After diffusion annealing, the weakly sintered powder cakes were gently crushed and sieved to a particle size substantially below 150 μm.

TABLE 1

| | | | | | Ni content |
|---|---|---|---|---|---|
| Diffusion | | Cu/Ni | D50 | Cu content | in diff. |
| annealed | Alloying | ratio | alloying | in diff. | annealed |
| iron-based | powder | of alloying | powder | annealed | powder |
| powder | used | powder | [μm] | powder [%] | [%] |
| 1 (reference) | Cu₂O | 100/0 | 8.8 | 10 | 0 |
| 2 (reference) | Cu₂O + | 100/0 | 8.8 | | |
| | Ni | 0/100 | 8.5 | 9 | 1 |
| 3 (invention) | Cu—Ni | 9/1 | 8.5 | 9 | 1 |
| | alloy | | | | |
| | powder | | | | |

Table 1 shows particle size, D₅₀, and ratio of Cu and Ni of the alloying powders as well as Cu and Ni content of the diffusion annealed powders. The mean particle size, D₅₀, was analyzed by laser diffraction in a Sympatec instrument.

Three iron-based powder compositions consisting of 20% by weight of the diffusion annealed iron-based powders 1, 2 and 3 respectively, 0.5% by weight of graphite C- UF4 and 0.8% by weight of Amide Wax PM balanced by ASC 100.29, were produced by homogenously mixing the components.

The different compositions were compacted at 600 MPa into seven tensile strength samples, from each composition, according to ISO 2740. The samples were sintered at 1120° C. for 30 minutes in an atmosphere of 90% nitrogen/10% hydrogen. Dimensional change was measured as well as mechanical properties according to ISO 4492 and EN 10 002-1. Hardness, HV10, according to ISO 4498 was measured.

TABLE 2

| Diff annealed | | Dimensional | | | |
|---|---|---|---|---|---|
| iron-based | Dimensional | change, | | | |
| powder used in | change, | standard | | | |
| iron-based | mean | deviation | Tensile | Elonga- | Hard- |
| powder | value of 7 | of 7 | strength | tion | ness |
| composition | samples [%] | samples [%] | [MPa] | [%] | [HV10] |
| 1 (reference) | 0.34 | 0.007 | 437 | 3.2 | 135 |
| 2 (reference) | 0.29 | 0.006 | 436 | 3.6 | 139 |
| 3 (invention) | 0.22 | 0.004 | 424 | 3.8 | 135 |

Table 2 shows that a substantial reduction of the dimensional change between compacted and sintered part, as well as variation of dimensional change between different parts, are obtained when using diffusion the annealed iron-based powder of the invention.

Reference 2 shows that when cuprous oxide and nickel powder are used for making the diffusion bonded powder, the swelling during sintering was reduced. Sample 3 according to the invention has the same copper and nickel contents as reference 2, but shows a much more pronounced reduction of the swelling and scatter.

### Example 2

Various types of copper/nickel containing alloying powder according to Table 3, having different ratios of copper and nickel as well as different particle size distribution, were used as copper and nickel containing alloying powder. As reference a cuprous oxide powder, Cu₂O, available from American Chemet was used. The particle size distribution was analyzed by laser diffraction in a Sympatec instrument. In order to simplify the evaluation, powders having D₅₀ less than 8.5 μm was designated as “fine”, between 8.5 μm and less than 15.1 μm was designated as “medium” and above 15.1 as “coarse”.

TABLE 3

| Iron-based diffusion | | | |
|---|---|---|---|
| annealed powder No. | Ratio Cu/Ni | D₅₀ μm | |
| 1 (reference) | ∞ | 8.8 | (medium) |
| 2 | 19 | 7.1 | (fine) |
| 3 | 19 | 9.9 | (medium) |
| 4 | 19 | 15.5 | (coarse) |
| 5 | 9 | 4.7 | (fine) |
| 6 | 9 | 10.1 | (medium) |
| 7 | 9 | 21.1 | (coarse) |
| 8 | 4 | 4.2 | (fine) |
| 9 | 4 | 8.5 | (medium) |
| 10 | 4 | 15.1 | (coarse) |
| 11 | 1 | 6.4 | (fine) |

As base powder, a pure iron powder, ASC100.29 available from Höganäs AB, was used.

Various samples having a weight of 2 kg of diffusion bonded powder were prepared by mixing ASC 100.29 with the copper and nickel containing alloying powder in proportions giving a total content of copper and nickel in the diffusion bonded annealed powder of 10% by weight.

The reference sample was prepared by mixing the iron powder with the cuprous oxide giving a total content of copper in the diffusion bonded annealed powder of 10% by weight.

The mixed powder samples were annealed in a laboratory furnace at 800° C. for 60 minutes in an atmosphere of 75% hydrogen/25% nitrogen. After cooling, the obtained weakly sintered powder cakes were gently milled and sieved to a particle size substantially below 150 μm.

Thirty-three iron-based powder compositions consisting of 20% by weight of the diffusion annealed iron-based powders 1-11, 0.4, 0.6 and 0.8% by weight of graphite C-UF4 respectively, 0.8% by weight of Amide Wax PM, balanced by ASC100.29 were produced by homogenously mixing the components.

The different compositions were compacted at 600 MPa into tensile strength samples according to Example 1.

Tensile tests samples made from compositions having 0.6% graphite added, were sintered at three different temperatures, 1090° C., 1120° C. and 1150° C. for 30 minutes, respectively, in an atmosphere of 90% nitrogen/10% hydrogen, seven samples for each sintering run. Samples made from compositions containing 0.4% added graphite and samples made from compositions containing 0.8% added graphite were sintered at 1120° C. for 30 minutes in an atmosphere of 90% nitrogen/10% hydrogen, also seven samples per sintering run. Dimensional change was measured as well as mechanical properties including hardness according to the procedures described in Example 1.

The following Table 4 describes the test series.

TABLE 4

| | Graphite added to | |
|---|---|---|
| | compositions 1-11 | Sintering temp |
| Test series | [% by weight] | [° C.] |
| A | 0.4 | 1120 |
| B1 | 0.6 | 1120 |
| B2 | 0.6 | 1150 |
| B3 | 0.6 | 1190 |
| C | 0.8 | 1120 |

Test Series

The following Table 5 shows the results from measurements of dimensional change during sintering as well as results from analysis of C, Cu and Ni content of sintered samples.

TABLE 5

| | diffusion | Graphite | Sintering | Dimensional | Stand. deviation | | Analyzed | Analyzed |
|---|---|---|---|---|---|---|---|---|
| | annealed | addition | temperature | change DC | between A, B1, | Analyzed C | Cu | Ni |
| Test series | powder No. | (%) | (° C.) | (%) | B2, B3, C (%) | (%) | (%) | (%) |
| A | 1 | 0.4 | 1120 | 0.37 | | 0.37 | 2.12 | 0.02 |
| B1 | 1 | 0.6 | 1090 | 0.33 | | 0.56 | 2.04 | 0.02 |
| B2 | 1 | 0.6 | 1120 | 0.31 | | 0.56 | 2.02 | 0.02 |
| B3 | 1 | 0.6 | 1150 | 0.24 | | 0.55 | 2.03 | 0.02 |
| C | 1 | 0.8 | 1120 | 0.19 | 0.072 | 0.75 | 2.10 | 0.02 |
| A | 2 | 0.4 | 1120 | 0.31 | | 0.38 | 1.95 | 0.12 |
| B1 | 2 | 0.6 | 1090 | 0.27 | | 0.55 | 1.89 | 0.11 |
| B2 | 2 | 0.6 | 1120 | 0.26 | | 0.55 | 1.88 | 0.11 |
| B3 | 2 | 0.6 | 1150 | 0.21 | | 0.55 | 1.90 | 0.11 |
| C | 2 | 0.8 | 1120 | 0.19 | 0.049 | 0.74 | 1.97 | 0.12 |
| A | 3 | 0.4 | 1120 | 0.32 | | 0.36 | 1.95 | 0.12 |
| B1 | 3 | 0.6 | 1090 | 0.28 | | 0.54 | 1.88 | 0.12 |
| B2 | 3 | 0.6 | 1120 | 0.27 | | 0.56 | 1.83 | 0.12 |
| B3 | 3 | 0.6 | 1150 | 0.22 | | 0.56 | 1.88 | 0.12 |
| C | 3 | 0.8 | 1120 | 0.19 | 0.052 | 0.76 | 1.96 | 0.12 |
| A | 4 | 0.4 | 1120 | 0.32 | | 0.35 | 1.92 | 0.14 |
| B1 | 4 | 0.6 | 1090 | 0.29 | | 0.54 | 1.88 | 0.14 |
| B2 | 4 | 0.6 | 1120 | 0.27 | | 0.54 | 1.86 | 0.14 |
| B3 | 4 | 0.6 | 1150 | 0.23 | | 0.54 | 1.87 | 0.14 |
| C | 4 | 0.8 | 1120 | 0.19 | 0.051 | 0.76 | 2.00 | 0.15 |
| A | 5 | 0.4 | 1120 | 0.20 | | 0.36 | 1.66 | 0.27 |
| B1 | 5 | 0.6 | 1090 | 0.17 | | 0.54 | 1.59 | 0.25 |
| B2 | 5 | 0.6 | 1120 | 0.16 | | 0.55 | 1.58 | 0.25 |
| B3 | 5 | 0.6 | 1150 | 0.14 | | 0.55 | 1.61 | 0.25 |
| C | 5 | 0.8 | 1120 | 0.15 | 0.025 | 0.74 | 1.67 | 0.27 |
| A | 6 | 0.4 | 1120 | 0.22 | | 0.38 | 1.75 | 0.29 |
| B1 | 6 | 0.6 | 1090 | 0.19 | | 0.55 | 1.71 | 0.28 |
| B2 | 6 | 0.6 | 1120 | 0.19 | | 0.54 | 1.72 | 0.28 |
| B3 | 6 | 0.6 | 1150 | 0.17 | | 0.55 | 1.72 | 0.28 |
| C | 6 | 0.8 | 1120 | 0.16 | 0.025 | 0.74 | 1.79 | 0.29 |
| A | 7 | 0.4 | 1120 | 0.27 | | 0.35 | 1.82 | 0.30 |
| B1 | 7 | 0.6 | 1090 | 0.20 | | 0.55 | 1.71 | 0.27 |
| B2 | 7 | 0.6 | 1120 | 0.21 | | 0.54 | 1.67 | 0.27 |
| B3 | 7 | 0.6 | 1150 | 0.18 | | 0.55 | 1.71 | 0.28 |
| C | 7 | 0.8 | 1120 | 0.19 | 0.034 | 0.73 | 1.89 | 0.31 |
| A | 8 | 0.4 | 1120 | 0.17 | | 0.38 | 1.67 | 0.40 |
| B1 | 8 | 0.6 | 1090 | 0.14 | | 0.54 | 1.67 | 0.40 |
| B2 | 8 | 0.6 | 1120 | 0.16 | | 0.54 | 1.66 | 0.39 |
| B3 | 8 | 0.6 | 1150 | 0.13 | | 0.54 | 1.67 | 0.39 |
| C | 8 | 0.8 | 1120 | 0.14 | 0.019 | 0.76 | 1.69 | 0.41 |
| A | 9 | 0.4 | 1120 | 0.17 | | 0.38 | 1.66 | 0.41 |
| B1 | 9 | 0.6 | 1090 | 0.13 | | 0.55 | 1.57 | 0.40 |
| B2 | 9 | 0.6 | 1120 | 0.15 | | 0.55 | 1.58 | 0.39 |
| B3 | 9 | 0.6 | 1150 | 0.12 | | 0.55 | 1.59 | 0.40 |
| C | 9 | 0.8 | 1120 | 0.13 | 0.020 | 0.74 | 1.65 | 0.41 |
| A | 10 | 0.4 | 1120 | 0.19 | | 0.38 | 1.64 | 0.44 |
| B1 | 10 | 0.6 | 1090 | 0.13 | | 0.54 | 1.55 | 0.42 |
| B2 | 10 | 0.6 | 1120 | 0.15 | | 0.57 | 1.55 | 0.42 |
| B3 | 10 | 0.6 | 1150 | 0.12 | | 0.53 | 1.56 | 0.42 |
| C | 10 | 0.8 | 1120 | 0.14 | 0.023 | 0.71 | 1.72 | 0.46 |
| A | 11 | 0.4 | 1120 | −0.01 | | 0.37 | 1.05 | 1.01 |
| B1 | 11 | 0.6 | 1090 | −0.01 | | 0.56 | 1.04 | 1.00 |
| B2 | 11 | 0.6 | 1120 | −0.03 | | 0.55 | 1.02 | 0.99 |
| B3 | 11 | 0.6 | 1150 | −0.06 | | 0.55 | 1.01 | 1.98 |
| C | 11 | 0.8 | 1120 | −0.02 | 0.020 | 0.74 | 1.04 | 1.01 |

The following Table 6 shows the result from mechanical testing of samples made from pressed and sintered compositions consisting of 20% by weight of different iron-based diffusion annealed powders, 0.8% by weight of Amide Wax PM, 0.6% of graphite, balanced by ASC100.29.

Sintering was conducted 1120° C. for 30 minutes in an atmosphere of 90% nitrogen/10% hydrogen.

TABLE 6

| Iron-based | | D₅₀ μm of iron- | | Tensile | |
|---|---|---|---|---|---|
| diffusion annealed | Ratio | based diffusion | | strength | Hardness |
| powder No. | Cu/Ni | annealed powder | | [MPa] | HV10 |
| 1 (reference) | ∞ | 8.8 | (medium) | 504 | 150 |
| 2 | 19 | 7.1 | (fine) | 500 | 148 |
| 3 | 19 | 9.9 | (medium) | 507 | 154 |
| 4 | 19 | 15.5 | (coarse) | 506 | 144 |
| 5 | 9 | 4.7 | (fine) | 479 | 141 |
| 6 | 9 | 10.1 | (medium) | 498 | 146 |
| 7 | 9 | 21.1 | (coarse) | 492 | 133 |
| 8 | 4 | 4.2 | (fine) | 481 | 139 |
| 9 | 4 | 8.5 | (medium) | 488 | 141 |
| 10 | 4 | 15.1 | (coarse) | 489 | 134 |
| 11 | 1 | 6.4 | (fine) | 445 | 127 |

Diagrams 1 and 2, presenting the compiled test results, show that when the ratio Cu/Ni in the iron-based diffusion annealed powder is below 3/1 (above 30% of Ni) the hardness and tensile strength will be unacceptably affected.

Furthermore, diagram 3 shows that when the ratio Cu/Ni exceeds 9/1 (less than 10% Ni), the scatter of the dimensional change during sintering, related to variations in the carbon content and sintering temperature, will be unacceptably high.

### INDUSTRIAL APPLICABILITY

The present invention is applicable in powder metallurgical processes, where components produced from the new powder presents a minimum of variation of dimensional change from component to component.

1. A method of producing a diffusion alloyed powder comprising a total content of copper and nickel of at most 20% by weight, wherein the copper content is above 4.0 wt % and the ratio between copper and nickel is between 9/1 and 3/1, said powder consisting of an iron or iron-based core powder having particles of an alloying powder containing copper and nickel bonded to the surface of the core powder particles, comprising
providing a unitary alloying powder comprising copper and nickel, said unitary alloying powder having a particle size distribution such that D₅₀ is less than 15 μm,
mixing the unitary alloying powder with the core powder, and
heating the mixed powders in a non-oxidizing or reducing atmosphere to a temperature of 500-1000° C. during a period of 10-120 minutes to convert the alloying powder into a copper and nickel containing alloy, by diffusion bonding particles of the copper and nickel alloying powder to the surface of the iron or iron-based core powder.

2. A method as claimed in claim 1, wherein the unitary alloying powder is an alloy consisting essentially of copper and nickel.

3. A method as claimed in claim 1, wherein the unitary alloying powder essentially is a metal alloy, an oxide, carbonate, or other suitable compound of copper and nickel.

4. A method as claimed in claim 1, wherein the diffusion bonding of particles of copper and nickel alloying powder to the surface of the iron or iron-based core powder results in a weakly sintered cake, which is then crushed gently and sieved to a particle size essentially below 150 μm.

5. A method as claimed in claim 1, wherein the diffusion alloyed powder comprises a content of copper in the range of 5-15 wt % and a content of nickel is in the range of 0.5-5%.

6. A method as claimed in claim 1, wherein the diffusion alloyed powder comprises a total content of copper and nickel between 4% and 16% by weight.

7. A diffusion alloyed powder, comprising a total content of copper and nickel of at most 20% by weight, wherein the copper content is above 4.0 wt % and the ratio between copper and nickel is between 9/1 and 3/1, said powder consisting of an iron or iron-based core powder having particles of an average size less than 15 μm of a unitary alloying powder containing copper and nickel, bonded to the surface of the core particles.

8. A diffusion alloyed powder as claimed in claim 7, wherein the diffusion alloyed powder has a particle size essentially below 150 μm.

9. A diffusion alloyed powder as claimed in claim 7, wherein the content of copper is between 5-15 wt % and the content of nickel is between 0.5-5%.

10. A diffusion alloyed iron or iron-based powder composition, comprising the diffusion alloyed powder as claimed in claim 7, and in addition graphite and optionally at least one additive selected from the group consisting of organic lubricants, hard phase materials, solid lubricants and other alloying substances.

11. An iron based powder composition consisting of:
an iron or iron-based powder
a diffusion alloyed powder as claimed in claim 7,
up to 1% by weight of graphite, and
optionally at least one additive selected from the group consisting of organic lubricants, hard phase materials, solid lubricants and other alloying substances.

12. The composition according to claim 11, wherein the iron or iron-based powder consists of essentially pure iron.

13. The composition according to claim 11, wherein the total copper and nickel content does not exceed 5% by weight of the composition.

14. The composition according to claim 10, wherein the ratio between copper and nickel is between 9/1and 3/1.

15. A compacted and sintered part produced from a powder composition as claimed in claim 10.

16. A method as claimed in claim 2, wherein the diffusion bonding of particles of copper and nickel alloying powder to the surface of the iron or iron-based core powder results in a weakly sintered cake, which is then crushed gently and sieved to a particle size essentially below 150 μm.

17. A method as claimed in claim 3, wherein the diffusion bonding of particles of copper and nickel alloying powder to the surface of the iron or iron-based core powder results in a weakly sintered cake, which is then crushed gently and sieved to a particle size essentially below 150 μm.

18. A diffusion alloyed powder as claimed in claim 8, wherein the content of copper is between 5μ15 wt % and the content of nickel is between 0.5-5%.

19. An iron based powder composition consisting of:
an iron or iron-based powder
a diffusion alloyed powder as claimed in claim 8,
up to 1% by weight of graphite, and
optionally at least one additive selected from the group consisting of organic lubricants, hard phase materials, solid lubricants and other alloying substances.

20. An iron based powder composition consisting of:
an iron or iron-based powder
a diffusion alloyed powder as claimed in claim 9,
up to 1% by weight of graphite, and
optionally at least one additive selected from the group consisting of organic lubricants, hard phase materials, solid lubricants and other alloying substances.

21. The composition according to claim 12, wherein the total copper and nickel content does not exceed 5% by weight of the composition.
